(19) United States
(12) Patent Application Publication
(10) Pub. No.: US 2019/0229987 A1
(43) Pub. Date: Jul. 25, 2019

(54) METHODS AND APPARATUS TO DEPLOY VIRTUAL NETWORKING IN A DATA CENTER

(71) Applicant: NICIRA, INC., Palo Alto, CA (US)

(72) Inventors: Prashant Shelke, Pune (IN); Sharwari Phadnis, Pune (IN); Yogesh Vhora, Pune (IN); Sudarshan Mhalas, Pune (IN); Neha Pratik Dhakate, Pune (IN); Dipesh Bhatewara, Pune (IN)

(21) Appl. No.: 15/916,294

(22) Filed: Mar. 9, 2018

(30) Foreign Application Priority Data
Jan. 24, 2018 (IN) 201841002917

(51) Int. Cl. H04L 12/24; G06F 11/07; G06F 9/455

(52) U.S. Cl. CPC H04L 41/0806; H04L 41/12; G06F 11/0793; H04L 67/10; G06F 2009/45595; G06F 2009/45562; G06F 9/45558

(57) ABSTRACT

Methods and apparatus to deploy virtual networking in a data center are disclosed. An example apparatus includes: a user interface to receive configuration information for a virtual network system to be installed in a datacenter and store the configuration information in a configuration file; an execution engine to install the virtual network system within the datacenter and to configure the virtual network system based on the configuration file; and a certification engine to validate the deployment and, in response to detecting a deployment failure, presenting, via the user interface, options to response to the failure.

### RELATED APPLICATIONS

Benefit is claimed under 35 U.S.C. 119(a)-(d) to Foreign Application Serial No. 201841002917 filed in India entitled “METHODS AND APPARATUS TO DEPLOY VIRTUAL NETWORKING IN A DATA CENTER”, on Jan. 24, 2018, by NICIRA, INC., which is herein incorporated in its entirety by reference for all purposes.

### FIELD OF THE DISCLOSURE

The present disclosure relates generally to virtual networks and, more particularly, to methods and apparatus to deploy virtual networking in a data center.

### BACKGROUND

Virtualizing computer systems provide benefits such as an ability to execute multiple computer systems on a single hardware computer, replicating computer systems, moving computer systems among multiple hardware computers, and so forth. Virtualizing networks can provide additional benefits to leverage network infrastructure for multiple applications.

“Infrastructure-as-a-Service” (also commonly referred to as “IaaS”) generally describes a suite of technologies provided by a service provider as an integrated solution to allow for elastic creation of a virtualized, networked, and pooled computing platform (sometimes referred to as a “cloud computing platform”). Enterprises may use IaaS as a business-internal organizational cloud computing platform (sometimes referred to as a “private cloud”) that gives an application developer access to infrastructure resources, such as virtualized servers, storage, and networking resources. By providing ready access to the hardware resources required to run an application, the platform enables developers to build, deploy, and manage the lifecycle of a web application (or any other type of networked application) at a greater scale and at a faster pace than ever before.

Virtualized computing environments may include many processing units (e.g., servers). Other components include storage devices, networking devices (e.g., switches), etc. Current computing environment configuration relies on much manual user input and configuration to install, configure, and deploy the components of the computing environment. Particular applications and functionality must be placed in particular places (e.g., network layers) or the application/functionality will not operate properly.

### BRIEF DESCRIPTION OF THE DRAWINGS

FIG. 1 is a block diagram of an example virtualized computing system.

FIG. 2 is a block diagram of an example virtual network layout.

FIG. 3 is a block diagram of an example environment in which a virtual networking deployment generator generates a deployment and/or certification of the example datacenter.

FIG. 4 is a block diagram of an example implementation of the virtual networking deployment generator of FIG. 3.

FIG. 5 depicts flowcharts representative of computer readable instructions that may be executed to implement example virtual networking deployment generator 150.

FIGS. 6-7 illustrate example user interface reports that may be provided to an example administrator.

FIG. 8 is a block diagram of an example processing platform structured to execute the example machine-readable instructions of FIG. 5 to implement the example virtual networking deployment generator of FIGS. 3 and/or 4.

### DETAILED DESCRIPTION

Virtual computing is based on the deployment of many physical resources across a network, virtualizing the physical resources into virtual resources, and provisioning the virtual resources to perform computing services and applications. Example systems for virtualizing computer systems are described in U.S. patent application Ser. No. 11/903,374, entitled “METHOD AND SYSTEM FOR MANAGING VIRTUAL AND REAL MACHINES,” filed Sep. 21, 2007, and granted as U.S. Pat. No. 8,171,485, U.S. Provisional Patent Application No. 60/919,965, entitled “METHOD AND SYSTEM FOR MANAGING VIRTUAL AND REAL MACHINES,” filed Mar. 26, 2007, and U.S. Provisional Patent Application No. 61/736,422, entitled “METHODS AND APPARATUS FOR VIRTUALIZED COMPUTING,” filed Dec. 12, 2012, all three of which are hereby incorporated herein by reference in their entirety.

Virtualized computing platforms may provide many powerful capabilities for performing computing operations. However, taking advantage of these computing capabilities manually may be complex and/or require significant training and/or expertise. Prior techniques to providing computing platforms and services often require customers to understand details and configurations of hardware and software resources to establish and configure the cloud computing platform. Example methods and apparatus disclosed herein facilitate the management of virtual machine resources and virtual networks in software-defined data centers and other virtualized computing platforms.

A virtual machine is a software computer that, like a physical computer, runs an operating system and applications. An operating system installed on a virtual machine is referred to as a guest operating system. Because each virtual machine is an isolated computing environment, virtual machines (VMs) can be used as desktop or workstation environments, as testing environments, to consolidate server applications, etc. Virtual machines can run on hosts or clusters. The same host can run a plurality of VMs, for example.

Virtual networks associated with virtual machines can be managed via policies and rules. A network virtualization manager provides an infrastructure for consumption by an executing application (e.g., executing via a VM, etc.). Virtual networks are provisioned for applications being deployed in a data center. For example, network layers or planes and associated services are configured to allow an application VM to executed in one or more network layers. While prior implementations provision and configure network layers and services separately and manually, certain examples provision and configure network layers and services via automated definition and discovery to correlate tiered applications, determine information flow, and automatically define an application entity in a network layer (e.g., policy layer, management/policy layer, etc.).

Virtual networks can be used with virtual machines in SDDC and/or other cloud or cloud-like computing environments. Virtual networks can be managed (e.g., using NSX sold by VMware, Inc.) using policies and rules. Network and other infrastructure is configured for consumption by applications. Virtual network(s) are provisioned for such applications to be deployed in the SDDC.

Example Virtualization Environments

Many different types of virtualization environments exist. Three example types of virtualization environment are: full virtualization, paravirtualization, and operating system virtualization.

Full virtualization, as used herein, is a virtualization environment in which hardware resources are managed by a hypervisor (e.g., a virtual machine monitor (VMM) and/or other software, hardware, and/or firmware to create and execute virtual machines) to provide virtual hardware resources to a virtual machine. A computer or other computing device on which the hypervisor runs is referred to as a host machine or host computer, and each virtual machine running on the host machine is referred to as a guest machine. The hypervisor provides guest operating systems with a virtual operating platform and manages execution of the guest operating systems. In certain examples, multiple operating system instances can share virtualized hardware resources of the host computer.

In a full virtualization environment, the virtual machines do not have direct access to the underlying hardware resources. In a typical full virtualization environment, a host operating system with embedded hypervisor (e.g., VMware ESXi®) is installed on the server hardware. Virtual machines including virtual hardware resources are then deployed on the hypervisor. A guest operating system is installed in the virtual machine. The hypervisor manages the association between the hardware resources of the server hardware and the virtual resources allocated to the virtual machines (e.g., associating physical RAM with virtual RAM). Typically, in full virtualization, the virtual machine and the guest operating system have no visibility and/or direct access to the hardware resources of the underlying server. Additionally, in full virtualization, a full guest operating system is typically installed in the virtual machine while a host operating system is installed on the server hardware. Example full virtualization environments include VMware ESX®, Microsoft Hyper-V®, and Kernel Based Virtual Machine (KVM).

Paravirtualization, as used herein, is a virtualization environment in which hardware resources are managed by a hypervisor to provide virtual hardware resources to a virtual machine and guest operating systems are also allowed direct access to some or all of the underlying hardware resources of the server (e.g., without accessing an intermediate virtual hardware resource). In a typical paravirtualization system, a host operating system (e.g., a Linux-based operating system) is installed on the server hardware. A hypervisor (e.g., the Xen® hypervisor) executes on the host operating system. Virtual machines including virtual hardware resources are then deployed on the hypervisor. The hypervisor manages the association between the hardware resources of the server hardware and the virtual resources allocated to the virtual machines (e.g., associating physical random access memory (RAM) with virtual RAM). In paravirtualization, the guest operating system installed in the virtual machine is configured also to have direct access to some or all of the hardware resources of the server. For example, the guest operating system may be precompiled with special drivers that allow the guest operating system to access the hardware resources without passing through a virtual hardware layer. For example, a guest operating system may be precompiled with drivers that allow the guest operating system to access a sound card installed in the server hardware. Directly accessing the hardware (e.g., without accessing the virtual hardware resources of the virtual machine) may be more efficient, may allow for performance of operations that are not supported by the virtual machine and/or the hypervisor, etc.

Operating system virtualization is also referred to herein as container virtualization. As used herein, operating system virtualization refers to a system in which processes are isolated in an operating system. In a typical operating system virtualization system, a host operating system is installed on the server hardware. Alternatively, the host operating system may be installed in a virtual machine of a full virtualization environment or a paravirtualization environment. The host operating system of an operating system virtualization system is configured (e.g., utilizing a customized kernel) to provide isolation and resource management for processes that execute within the host operating system (e.g., applications that execute on the host operating system). The isolation of the processes is known as a container. Several containers may share a host operating system. Thus, a process executing within a container is isolated the process from other processes executing on the host operating system. Thus, operating system virtualization provides isolation and resource management capabilities without the resource overhead utilized by a full virtualization environment or a paravirtualization environment. Alternatively, the host operating system may be installed in a virtual machine of a full virtualization environment or a paravirtualization environment. Example operating system virtualization environments include Linux Containers LXC and LXD, Docker™, OpenVZ™, etc.

In some instances, a data center (or pool of linked data centers) may include multiple different virtualization environments. For example, a data center may include hardware resources that are managed by a full virtualization environment, a paravirtualization environment, and an operating system virtualization environment. In such a data center, a workload may be deployed to any of the virtualization environments.

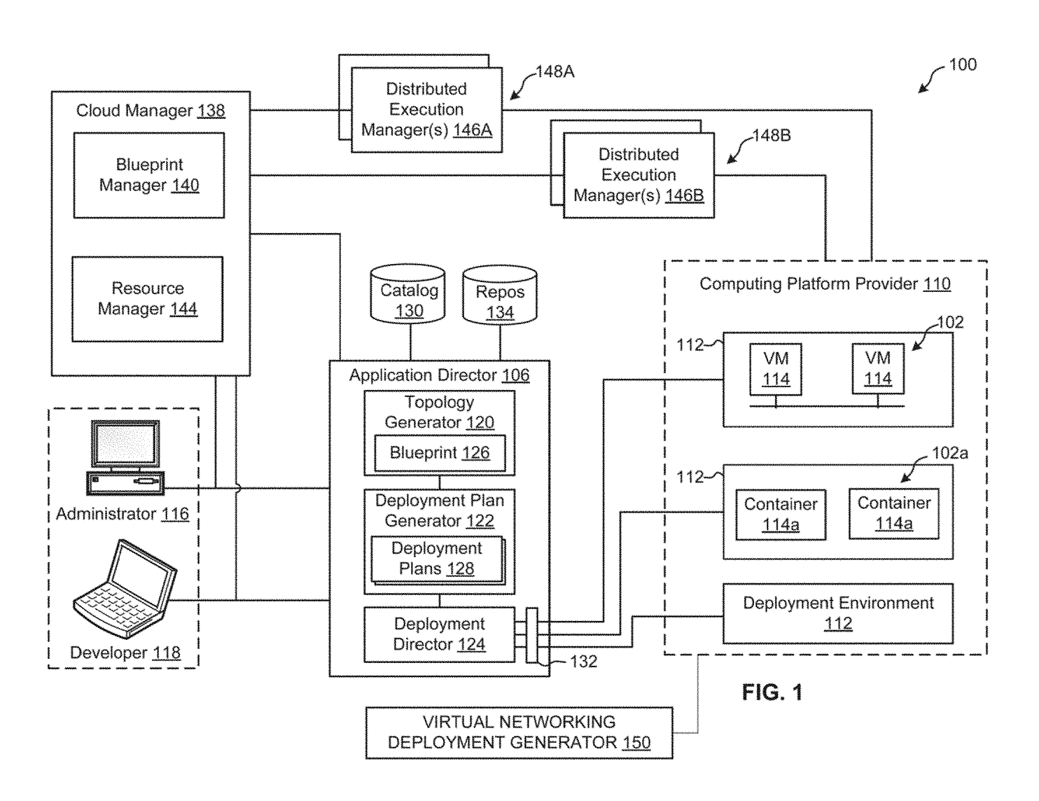

FIG. 1 depicts an example system 100 constructed in accordance with the teachings of this disclosure for managing a computing platform (e.g., a cloud computing platform and/or other distributed computing platform, etc.). The example system 100 includes an application director 106 and a manager 138 to manage a computing platform provider 110 as described in more detail below. As described herein, the example system 100 facilitates management of the provider 110 and does not include the provider 110. Alternatively, the system 100 can be included in the provider 110.

The computing platform provider 110 provisions virtual computing resources (e.g., virtual machines, or “VMs,” 114) that may be accessed by users of the computing platform 110 (e.g., users associated with an administrator 116 and/or a developer 118) and/or other programs, software, device. etc.

An example application 102 implemented via the computing platform provider 110 of FIG. 1 includes multiple VMs 114. The example VMs 114 of FIG. 1 provide different functions within the application 102 (e.g., services, portions of the application 102, etc.). One or more of the VMs 114 of the illustrated example are customized by an administrator 116 and/or a developer 118 of the application 102 relative to a stock or out-of-the-box (e.g., commonly available purchased copy) version of the services and/or application components. Additionally, the services executing on the example VMs 114 may have dependencies on other ones of the VMs 114.

As illustrated in FIG. 1, the example computing platform provider 110 may provide multiple deployment environments 112, for example, for development, testing, staging, and/or production of applications. The administrator 116, the developer 118, other programs, and/or other devices may access services from the computing platform provider 110, for example, via REST (Representational State Transfer) APIs (Application Programming Interface) and/or via any other client-server communication protocol. Example implementations of a REST API for cloud and/or other computing services include a vCloud Administrator Center™ (vCAC) and/or vRealize Automation™ (vRA) API and a vCloud Director™ API available from VMware, Inc. The example computing platform provider 110 provisions virtual computing resources (e.g., the VMs 114) to provide the deployment environments 112 in which the administrator 116 and/or the developer 118 can deploy multi-tier application(s). One particular example implementation of a deployment environment that may be used to implement the deployment environments 112 of FIG. 1 is vCloud DataCenter cloud computing services available from VMware, Inc.

In some examples disclosed herein, a lighter-weight virtualization is employed by using containers in place of the VMs 114 in the development environment 112. Example containers 114a are software constructs that run on top of a host operating system without the need for a hypervisor or a separate guest operating system. Unlike virtual machines, the containers 114a do not instantiate their own operating systems. Like virtual machines, the containers 114a are logically separate from one another. Numerous containers can run on a single computer, processor system and/or in the same development environment 112. Also like virtual machines, the containers 114a can execute instances of applications or programs (e.g., an example application 102a) separate from application/program instances executed by the other containers in the same development environment 112.

The example application director 106 of FIG. 1, which may be running in one or more VMs, orchestrates deployment of multi-tier applications onto one of the example deployment environments 112. As illustrated in FIG. 1, the example application director 106 includes a topology generator 120, a deployment plan generator 122, and a deployment director 124.

The example topology generator 120 generates a basic blueprint 126 that specifies a logical topology of an application to be deployed. The example basic blueprint 126 generally captures the structure of an application as a collection of application components executing on virtual computing resources. For example, the basic blueprint 126 generated by the example topology generator 120 for an online store application may specify a web application (e.g., in the form of a Java web application archive or “WAR” file including dynamic web pages, static web pages, Java servlets, Java classes, and/or other property, configuration and/or resources files that make up a Java web application) executing on an application server (e.g., Apache Tomcat application server) that uses a database (e.g., MongoDB) as a data store. As used herein, the term “application” generally refers to a logical deployment unit, including one or more application packages and their dependent middleware and/or operating systems. Applications may be distributed across multiple VMs. Thus, in the example described above, the term “application” refers to the entire online store application, including application server and database components, rather than just the web application itself. In some instances, the application may include the underlying hardware and/or virtual computing hardware utilized to implement the components.

The example basic blueprint 126 of FIG. 1 may be assembled from items (e.g., templates) from a catalog 130, which is a listing of available virtual computing resources (e.g., VMs, networking, storage, etc.) that may be provisioned from the computing platform provider 110 and available application components (e.g., software services, scripts, code components, application-specific packages) that may be installed on the provisioned virtual computing resources. The example catalog 130 may be pre-populated and/or customized by an administrator 116 (e.g., IT (Information Technology) or system administrator) that enters in specifications, configurations, properties, and/or other details about items in the catalog 130. Based on the application, the example blueprints 126 may define one or more dependencies between application components to indicate an installation order of the application components during deployment. For example, since a load balancer usually cannot be configured until a web application is up and running, the developer 118 may specify a dependency from an Apache service to an application code package.

The example deployment plan generator 122 of the example application director 106 of FIG. 1 generates a deployment plan 128 based on the basic blueprint 126 that includes deployment settings for the basic blueprint 126 (e.g., virtual computing resources' cluster size, CPU, memory, networks, etc.) and an execution plan of tasks having a specified order in which virtual computing resources are provisioned and application components are installed, configured, and started. The example deployment plan 128 of FIG. 1 provides an IT administrator with a process-oriented view of the basic blueprint 126 that indicates discrete actions to be performed to deploy the application. Different deployment plans 128 may be generated from a single basic blueprint 126 to test prototypes (e.g., new application versions), to scale up and/or scale down deployments, and/or to deploy the application to different deployment environments 112 (e.g., testing, staging, production). The deployment plan 128 is separated and distributed as local deployment plans having a series of tasks to be executed by the VMs 114 provisioned from the deployment environment 112. Each VM 114 coordinates execution of each task with a centralized deployment module (e.g., the deployment director 124) to ensure that tasks are executed in an order that complies with dependencies specified in the application blueprint 126.

The example deployment director 124 of FIG. 1 executes the deployment plan 128 by communicating with the computing platform provider 110 via an interface 132 to provision and configure the VMs 114 in the deployment environment 112. The example interface 132 of FIG. 1 provides a communication abstraction layer by which the application director 106 may communicate with a heterogeneous mixture of provider 110 and deployment environments 112. The deployment director 124 provides each VM 114 with a series of tasks specific to the receiving VM 114 (herein referred to as a “local deployment plan”). Tasks are executed by the VMs 114 to install, configure, and/or start one or more application components. For example, a task may be a script that, when executed by a VM 114, causes the VM 114 to retrieve and install particular software packages from a central package repository 134. The example deployment director 124 coordinates with the VMs 114 to execute the tasks in an order that observes installation dependencies between VMs 114 according to the deployment plan 128. After the application has been deployed, the application director 106 may be utilized to monitor and/or modify (e.g., scale) the deployment.

The example manager 138 of FIG. 1 interacts with the components of the system 100 (e.g., the application director 106 and the provider 110) to facilitate the management of the resources of the provider 110. The example manager 138 includes a blueprint manager 140 to facilitate the creation and management of multi-machine blueprints and a resource manager 144 to reclaim unused cloud resources. The manager 138 may additionally include other components for managing a cloud environment.

The example blueprint manager 140 of the illustrated example manages the creation of multi-machine blueprints that define the attributes of multiple virtual machines as a single group that can be provisioned, deployed, managed, etc. as a single unit. For example, a multi-machine blueprint may include definitions for multiple basic blueprints that make up a service (e.g., an e-commerce provider that includes web servers, application servers, and database servers). A basic blueprint is a definition of policies (e.g., hardware policies, security policies, network policies, etc.) for a single machine (e.g., a single virtual machine such as a web server virtual machine and/or container). Accordingly, the blueprint manager 140 facilitates more efficient management of multiple virtual machines and/or containers than manually managing (e.g., deploying) basic blueprints individually.

The example blueprint manager 140 of FIG. 1 additionally annotates basic blueprints and/or multi-machine blueprints to control how workflows associated with the basic blueprints and/or multi-machine blueprints are executed. As used herein, a workflow is a series of actions and decisions to be executed in a virtual computing platform. The example system 100 includes first and second distributed execution manager(s) (DEM(s)) 146A and 146B to execute workflows. According to the illustrated example, the first DEM 146A includes a first set of characteristics and is physically located at a first location 148A. The second DEM 146B includes a second set of characteristics and is physically located at a second location 148B. The location and characteristics of a DEM may make that DEM more suitable for performing certain workflows. For example, a DEM may include hardware particularly suited for performance of certain tasks (e.g., high-end calculations), may be located in a desired area (e.g., for compliance with local laws that require certain operations to be physically performed within a country's boundaries), may specify a location or distance to other DEMS for selecting a nearby DEM (e.g., for reducing data transmission latency), etc. Thus, the example blueprint manager 140 annotates basic blueprints and/or multi-machine blueprints with capabilities that can be performed by a DEM that is labeled with the same or similar capabilities.

The resource manager 144 of the illustrated example facilitates recovery of computing resources of the provider 110 that are no longer being activity utilized. Automated reclamation may include identification, verification and/or reclamation of unused, underutilized, etc. resources to improve the efficiency of the running cloud infrastructure.

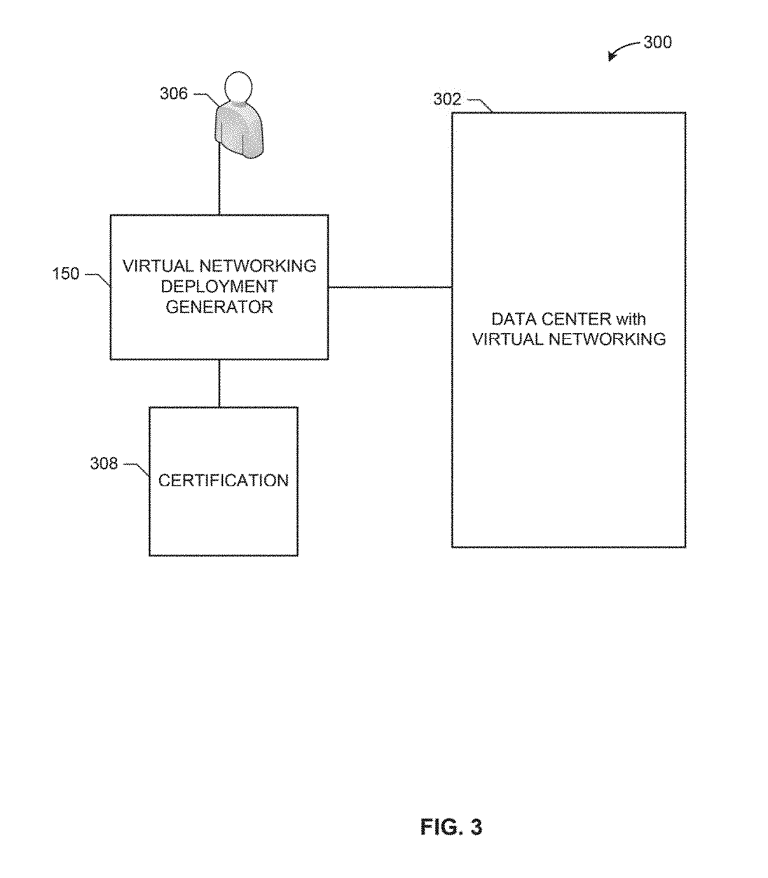

According to the illustrated example, an example virtual networking deployment generator 150 is deployed in the example infrastructure 100. The example virtual networking deployment generator 150 operates to deploy and certify a virtual network product (e.g., NSX) in the example computing platform 110. Further details of the virtual networking deployment generator 150 are discussed in conjunction with FIGS. 3-5.

Network Virtualization Examples

Software-defined networking (SDN) provides computer networks in which network behavior can be programmatically initialized, controlled, changed, and managed dynamically via open interface(s) and abstraction of lower-level functionality. As with VMs, SDN or network virtualization addresses the problem that the static architecture of traditional networks does not support the dynamic, scalable computing and storage needs of more modern computing environments such as data centers. By dividing a network into a set of planes (e.g., control plane, data plane, management or policy plane, etc., a system that determines where network traffic is sent (e.g., an SDN controller, or control plane) can be separated from underlying systems that forward traffic to the selected destination (e.g., the data plane, etc.).

In a network, a plane is an architectural component or area of operation for the network. Each plane accommodates a different type of data traffic and runs independently on top of the network hardware infrastructure. The data plane (sometimes also referred to as the user plane, forwarding plane, carrier plane, or bearer plane) carries network user traffic. The control plane carries signaling data traffic. Control packets carried by the control plane originate from or are destined for a router, for example. The management or policy plane, which carries administrative data traffic, is considered a subset of the control plane.

In conventional networking, the three planes are implemented in the network firmware of routers and switches. SDN decouples the data and control planes to implement the control plane in software rather than network hardware. Software implementation enables programmatic access and adds flexibility to network administration. For example, network traffic can be shaped via the control plane from a centralized control console without having to adjust individual network switches. Additionally, switch rules can be dynamically adjusted such as to prioritize, de-prioritize, block, etc., certain packet types, etc.

Each network plane is associated with one or more data transfer/communication protocols. For example, interfaces, Internet Protocol (IP) subnets and routing protocols are configured through management plane protocols (e.g., Command Line Interface (CLI), Network Configuration Protocol (NETCONF), Representational State Transfer (RESTful) application programming interface (API), etc.). In certain examples, a router runs control plane routing protocols (e.g., OSPF, EIGRP, BGP, etc.) to discover adjacent devices and network topology information. The router inserts the results of the control-plane protocols into table(s) such as a Routing Information Base (RIB), a Forwarding Information Base (FIB), etc. Data plane software and/or hardware (e.g., application specific integrated circuits (ASICs), field programmable gate arrays (FPGAs), etc.) use FIB structures to forward data traffic on the network. Management/policy plane protocols, such as Simple Network Management Protocol (SNMP), can be used to monitor device operation, device performance, interface counter(s), etc.

A network virtualization platform decouples the hardware plane from the software plane such that the host hardware plane can be administratively programmed to assign its resources to the software plane. Such programming allows for virtualization of central processing unit (CPU) resources, memory, other data storage, network input/output (TO) interface, and/or other network hardware resource. Virtualization of hardware resources facilitates implementation of a plurality of virtual network applications such as firewalls, routers, Web filters, intrusion prevention systems, etc., contained within a single hardware appliance. Thus, logical or “virtual” networks can be created on top of a physical network, and the virtual networks can have the same properties as the underlying physical network.

Within a network virtualization environment, applications are interconnected by a virtual switch, rather than a physical, hardware-based network switch. Virtual switches are software-based “switches” that involve movement of packets up and down a software stack which relies on the same processor(s) that are being used to drive the applications. The virtual switch (also referred to as a soft switch or vSwitch) can be implemented on each server in a virtual network, and packets can be encapsulated across multiple vSwitches that forward data packets in a network overlay on top of a physical network as directed by a network controller that communicates to the vSwitch via a protocol such as OpenFlow, etc.

Thus, in a close analogy to a virtual machine, a virtualized network is a software container that presents logical network components (e.g., logical switches, routers, firewalls, load balancers, virtual private networks (VPNs), etc.) to connected workloads. The virtualized networks are programmatically created, provisioned and managed, with the underlying physical network serving as a simple packet-forwarding backplane for data traffic on the virtual network. Network and security services are allocated to each VM according to its needs, and stay attached to the VM as the VM moves among hosts in the dynamic virtualized environment. A network virtualization platform (e.g., VMware's NSX, etc.) deploys on top of existing physical network hardware and supports fabrics and geometries from a plurality of vendors. In certain examples, applications and monitoring tools work smoothly with the network virtualization platform without modification.

In certain examples, the virtual network introduces a new address space enabling logical networks to appear as physical networks. For example, even if the physical network is L3 (Layer 3), an L2 (Layer 2) virtual network can be created. As another example, if the physical network is L2, an L3 virtual network can be created. When a data packet leaves a VM, for example, the packet is sent to the physical network via lookup from the virtual network. The packet can then be transported back from the physical network to the virtual network for further computation and/or other processing at its destination (e.g., virtual network address spaces can be mapped to a physical address space along a network edge in real time or substantially real time given system processing, transmission, and/or data storage latency, etc.). Thus, the virtual network is decoupled from the physical network. An abstraction layer is created and managed between end systems and the physical network infrastructure which enables creation of logical networks that are independent of the network hardware.

For example, two VMs located at arbitrary locations in a data center (and/or across multiple data centers, etc.) can be connected by a logical overlay networks such that the two VMs think that they are on the same physical network connected by a single switch between the VMs. The overlay network is implemented by a network tunnel that is established between the host computers on which the two VMs reside. When the first VM sends out a packet to the second VM, the packet's L2 header is encapsulated by an L3 header addressed to the second host, and then another L2 header is generated for the first hop toward the second host for the second VM (e.g., the destination host). The destination host then unpackages the packet and provides the inner, original packet to the second VM. Routing from the first VM to the second VM can be orchestrated by a central controller cluster which knows a location for each VM and translates logical switch configuration to physical switch configuration to program the physical forwarding plane with instructions to encapsulate and forward the packet according to the translation(s). A management server receives user configuration input, such as logical network configuration, and communicates the input to the controller cluster via one or more APIs, for example.

The controller cluster also handles higher-level constructs such as logical L3 routers, which are distributed across the hosts that have VMs that are connected to the logical router. Each logical router can include capabilities of physical routers, including network address translation (NAT), secure NAT (SNAT), access control list (ACL), etc. The controller cluster can also implement distributed firewalls, load balancers, etc. Firewall rules can be applied at each port of the virtual switch according to a configuration, for example.

Certain examples provide a novel architecture to capture contextual attributes on host computers that execute one or more virtual machines and consume captured contextual attributes to perform services on the host computers. Certain examples execute a guest-introspection (GI) agent on each machine from which contextual attributes are to be captured. In addition to executing one or more VMs on each host computer, certain examples also execute a context engine and one or more attribute-based service engines on each host computer. Through the GI agents of the VMs on a host, the context engine of the host, in some examples, collects contextual attributes associated with network events and/or process events on the VMs. The context engine then provides the contextual attributes to the service engines, which, in turn, use these contextual attributes to identify service rules that specify context-based services to perform on processes executing on the VMs and/or data message flows sent by or received for the VMs.

As used herein, data messages refer to a collection of bits in a particular format sent across a network. The term data message can be used herein to refer to various formatted collections of bits that may be sent across a network, such as Ethernet frames, IP packets, TCP segments, UDP datagrams, etc. Also, as used herein, references to L2, L3, L4, and L7 layers (or layer 2, layer 3, layer 4, layer 7) are references respectively to the second data link layer, the third network layer, the fourth transport layer, and the seventh application layer of the OSI (Open System Interconnection) layer model.

Network Plane System

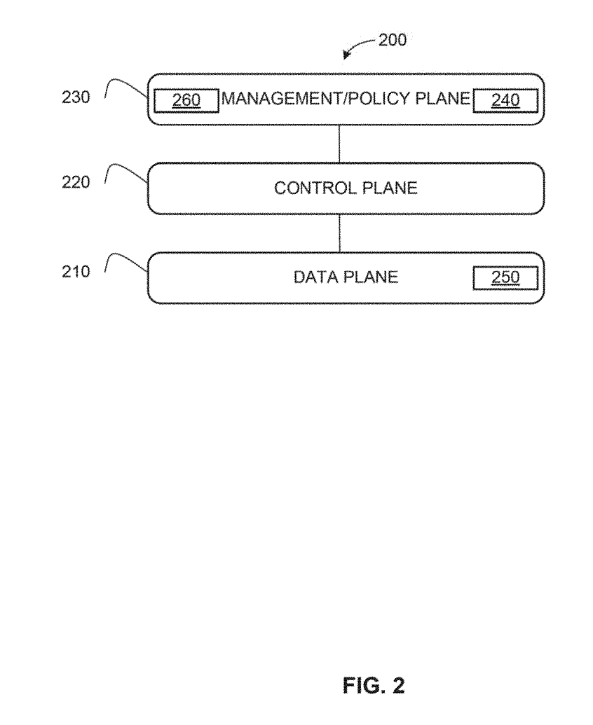

Networks, including virtual networks, can be logically divided into a plurality of planes or layers. FIG. 2 illustrates an example network layout 200 including a data plane 210, a control plane 220, and a management/policy plane 230. As shown in the example of FIG. 2, the data plane 210 facilitates switching and data packet forwarding (e.g., according to a forwarding table, etc.), etc. The data plane 210 determines network address translation, neighbor address, netflow accounting, access control list (ACL) logging, error signaling, etc. The control plane 220 facilitates routing including static routes, neighbor information, IP routing table, link state, etc. Protocols executing on the control plane 220 facilitate routing, interface state management, connectivity management, adjacent device discovery, topology/reachability information exchange, service provisioning, etc. The management/policy plane 230 facilitates network configuration and interfacing, including command line interface (CLI), graphical user interface (GUI), etc.

While the control plane 220 and data plane 210 accommodate networking constructs such as routers, switches, and ports, these planes 210, 220 do not understand compute constructs such as applications, etc. Certain examples instantiate application entities in the management plane 230. Rather than manually tying applications to network behavior, certain examples provide a technological improvement to computing system and networking infrastructure and operations by automatically identify executing applications, instantiate corresponding application entities in the management plane 230, and tie applications to network interactions for display and/or interaction by an operator.

In certain examples, the infrastructure 100 can be leveraged to drive identification and management of applications and/or other resources at the policy layer. Certain examples enable definition of applications executing in a virtualized network environment in the policy layer. Certain examples facilitate definition of an application entity in the policy layer. The application entity is a logical manageable entity that includes a group of VMs 114 to execute the associated application.

In certain examples, a multi-tier application (e.g., a three-tier application, n-tier application, etc.) is divided into one group of VMs 114 per application tier. For example, a three-tier application (e.g., presentation tier, business logic tier, and data tier) has three VM 114 groups—one tier for Web presentation, one group for application logic, and one group for datastore.

Certain examples facilitate discovery of user logins via VMs 114 and associated applications executing to generate data and command flows via a context engine. The context engine discovers individual processes running within VMs 114 and/or users logging into the VMs 114. Process(es) and user(s) can be correlated into tiered application(s) that the policy layer has defined. Flow information of the user and/or application can be discovered as well as another user and/or application connected to the flow, for example.

For example, an L2/L3 network to which executing application(s) belong can be identified using a network virtualization manager (e.g., an API associated with VMware NSX®, etc.). Discovered information (e.g., user logins, activated VMs, running applications, flow information, etc.) can be visualized. Additionally, network(s) (e.g., L2/L3 networks, etc.) can be created, and application(s) can be placed in such network(s) based on the discovered information. Networking and security service(s) can be provided to these application(s). DFW, LB, antivirus (AV), and/or other partner service can be applied to user(s) and/or application(s) configured and/or discovered according to the network(s). In certain examples, the configuration can be saved as a template for reuse (e.g., by an administrator, through automated script execution, etc.) for a new user and/or application.

As described above, network virtualization functionality can be positioned in various planes of the network structure 200. For example, the context engine can be implemented in the management plane 230, data plane 210, and/or control plane 220.

In certain examples, the context engine can be implemented in the management plane 230 and the data plane 210. As shown in the example of FIG. 2, the context engine is implemented in two parts as a context engine management plane (MP) 240 and a context engine data plane (DP) 250. Together the context engine MP 240 and the context engine DP 250 perform the functions of the context engine.

In certain examples, a policy engine 260 (also referred to as a policy manager) and/or other operations and management component(s) can be implemented in the management plane 230, data plane 210, and/or control plane 220, for example. The policy engine 260 creates, stores, and/or distributes policy(-ies) to applications running on the virtual network(s) and VM(s) 114, for example.

Deploying virtualized network components in an environment such as the example system 100 of FIG. 1 may be very challenging. For example, for customers coming from traditional datacenter and hardware networking backgrounds may have difficulty understanding, deploying an configuring a virtual network component such as NSX® from VMWARE®. Further difficulties may be presented when validating the system for a business use case to be implemented. Customers demand testing evidence, audits, certification reports, etc. instead of verbal assurances and recommendations. Attempts to address those concerns using beta testing, hands-on lab deployments, and community programs for customers may be helpful for customers to get clear insights into product functionality and to gain confidence, but these approaches may not address all concerns of a customer or potential customer. Furthermore, back-and-forth discussions induce delays in the customer's go-to cycle for production deployments.

In some example disclosed herein, methods and apparatus provide tangible test certification evidence to address installation, configuration, feature, and various use cases stability. In some examples disclosed herein, a virtual networking deployment generator is provided to perform automated deployment and configuration to avoid deployment errors and misconfiguration in production environments. In addition, in some examples disclosed herein, the virtual networking deployment generator certifies the deployment of a virtual networking product on different quality aspects such as functional verification using command line interface, graphical user interface, and application programming interface, security, system, scale, performance, load verification in staging and/or in production environments, etc. before rolling out the system for actual production use. Such an approach helps customers detect problems earlier and reduce the elongated sales go-to production deployment cycles associated with the deployment of virtual network products.

FIG. 3 is a block diagram of an example environment 300 in which a data center 302 operates. According to the illustrated example, a virtual networking deployment generator operates to deploy and certify a virtual network product (e.g., NSX) in the data center 300.

The example data center 302 may be any type of data center in which a virtual networking product is to be deployed. For example, the data center 302 may operate a virtualized computing platform including hypervisor(s), guest virtual machine(s), etc. According to the illustrated example, the data center 302 includes a virtual network product that is awaiting deployment (e.g., NSX from VMware). For example, the software and/or licensing for the virtual network may be installed with an environment such as computing platform provider 110, within multiple computing platform providers 110, etc. The example data center 302 includes one or more hypervisors, kernel virtual machines, virtual networking managers (e.g., NSX managers), virtual network controllers (e.g., NSX controllers), virtual network edges (e.g., NSX edges), and guest virtual machines.

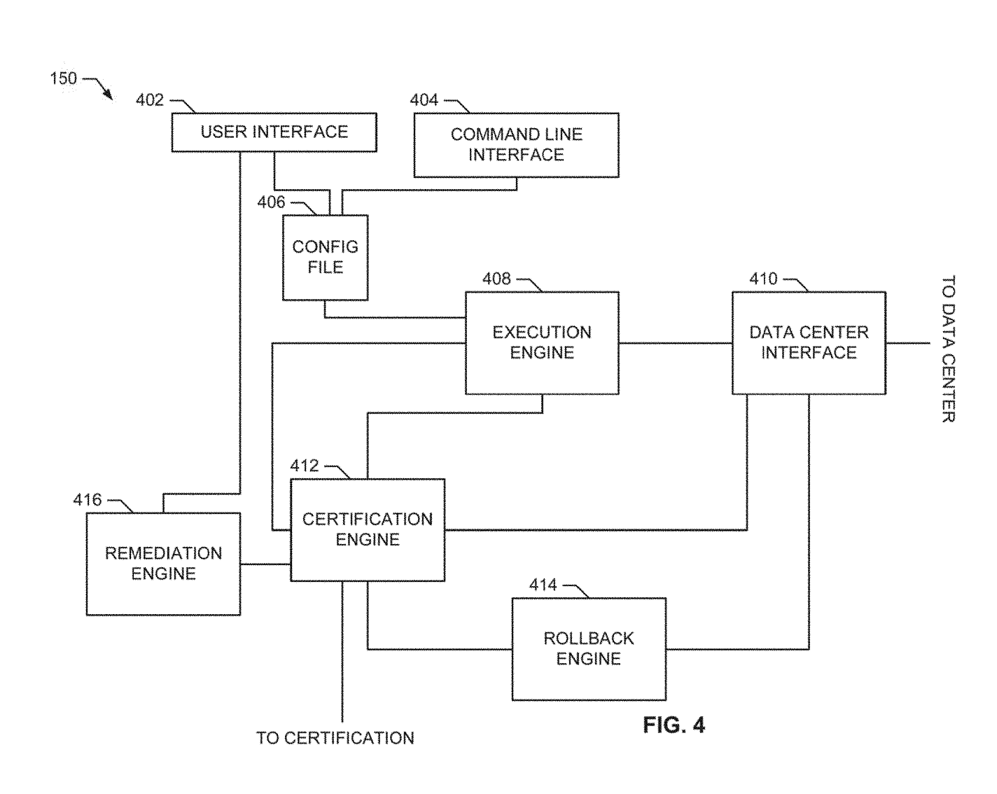

The example virtual networking deployment generator 150 is a centralized controller virtual machine that interfaces with the example administrator 306 to facilitate deployment and certification of a virtual networking system (e.g., NSX) within the example data center 302. As described in further detail in conjunction with FIG. 4, the example virtual networking deployment generator 150 receives a configuration specified by the administrator 306, deploys the virtual networking system according to the configuration, performs certification tests according to rules/policies specified by the administrator 306, provides an indication of errors to the administrator 306, attempts to remediate the errors, and if a certification succeeds, outputs the example certification 308. The example virtual networking deployment generator 150 is a virtual appliance that is deployed by the administrator 306 outside of the data center 302. Alternatively, the virtual networking deployment generator 150 may be deployed as any other type of system (e.g., a virtual machine, a server, software installed on a server, etc. Additionally or alternatively, the virtual networking deployment generator 150 may be deployed within the data center 302.

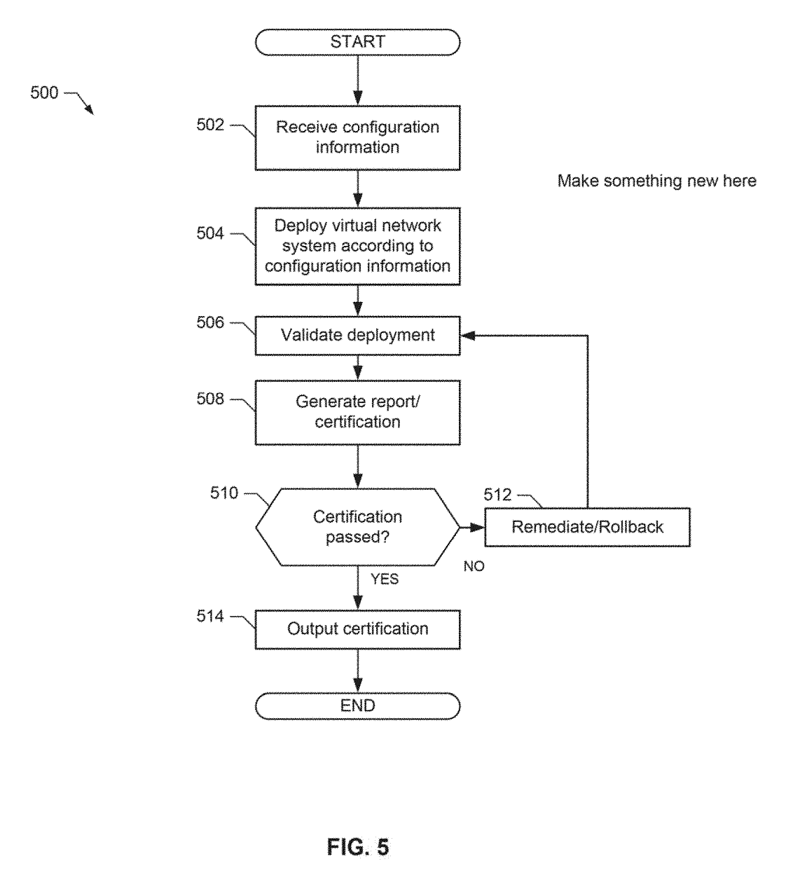

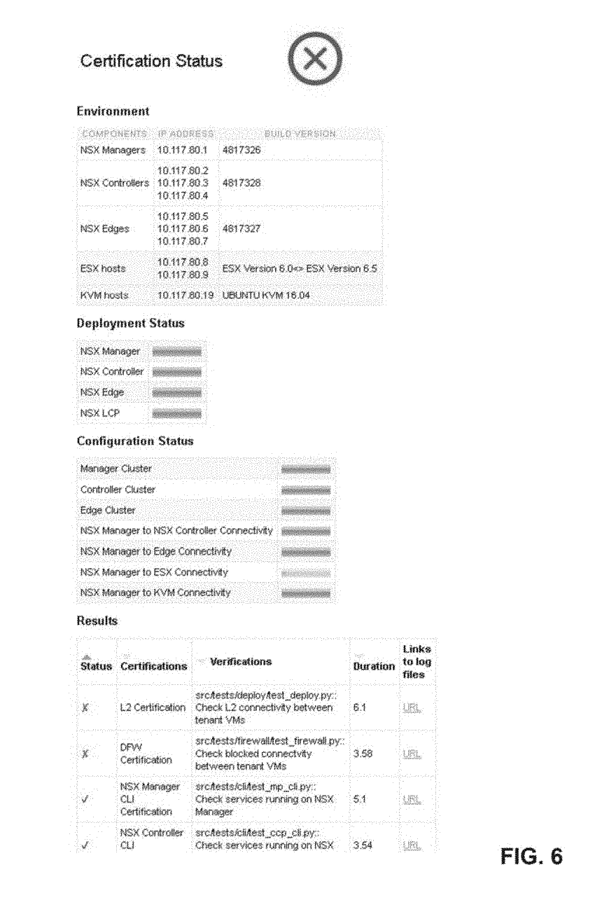

The example certification 308 is a report indicating whether the deployment specified in the configuration from the example administrator 306 met the tests specified (e.g., by the administrator 306) for certification. Example certification reports are illustrated in FIGS. 5 and 6.

FIG. 4 is a block diagram of an example implementation of the virtual networking deployment generator 150 of FIG. 3. The example virtual networking deployment generator 150 of FIG. 4 includes an example user interface 402, an example command line interface 404, an example config file 406, an example execution engine 408, an example data center interface 410, an example certification engine 412, an example rollback engine 414, and an example remediation engine 416.

The example user interface 402 and the example command line interface 404 provide an interface to receive instructions from and provide information to the example administrator 306. According to the illustrated example, the user interface 402 is a graphical user interface that is a web interface provided by a web server hosted by the example virtual networking deployment generator 150. Using the user interface 402 and/or the command line interface 404, the administrator 306 provides configuration information that is stored in the example config file 406. For example, the configuration information may include network parameters such as identification of devices that belong to sub-networks (e.g., devices that are to be connected by the virtual network), network addressing schemes, identification of managers, controllers, edges, hosts, etc. The example user interface 402 and/or the example user interface 404 may be driven by a master script that operates the example virtual networking deployment generator 150 to perform deployment and configuration.

The example execution engine 408 processes the example config file 406 and deploys the topology identified in the config file 406 datacenter via the example data interface 410. In some examples, the execution engine 408 may interface with the data center 302 via a deployment tool to deploy the virtual networking (e.g., may interface with the data center 302 using an automation tool such Ansible). Using a single pane of glass deployment using the example config file 406 (even when a distributed deployment is performed) reduces the changes of mistakes by a user when configuring the data center 202.

The example data center interface 410 communicatively couples the example execution engine 408, the example certification engine 412, and the example rollback engine 414 with the example data center 302. The example data center interface 410 may access an application programming interface, a user interface, a command line interface, etc. of the example data center 302.

The example certification engine 412 examines the configuration of the virtual network system within the data center 302 and processes rules to determine if the virtual network deployment meets certification rules. The example certification rules may be policies and/or rules that confirm that the deployment. For example, the certification engine 412 may utilize test automation tools to validate the deployment of the virtual networking system. The rules and/or policies to be tested may be provided by the example administrator 306. For example, example certification rules include:
Checking if all deployed appliances have retained configurations (e.g., IP addresses)
Checking that there are no errors in logs
Checking if all services from a Management Plane and/or Control Plane are up and running without any failures
Checking if a Management Plane Cluster and/or Control Plane Cluster are stable
Checking connectivity between the Management/Policy Plane and other planes
Checking layer 2 connectivity between virtual machines configured with Overlay network internet protocol addresses
Checking if appropriate Distributed Firewall rules (DFW) are applied to virtual machines

For example, the certification engine 412 may verify that the virtual network system components have deployed correctly. Verifying the components may include determining if components are running, determining if any components report and/or have logged an error, verifying an installation log, querying a component to determine if a valid response is received, etc. Components may include any number of components of a virtual network system (e.g., the components may include one or more components of an NSX installation: appliances, vSphere Installation Bundles (VIBS), resource packages, etc.).

The certification engine 412 may additionally validate each appliance of the virtual network system. For example, the certification engine 412 query and/or otherwise check for proper operation of virtual network system services. The certification engine 412 may check versions of components of the virtual network system to confirm that the versions are up to date and/or that all versions are compatible based on a compatibility table. The certification engine 412 may check that resulting hardware and/or network configurations meet requested hardware and/or network configurations. The certification engine 412 may additionally analyze logs to ensure that there were no errors, may verify that log rotation is operating, may verify that command line interface command execute successfully, etc.

The example certification engine 412 may additionally or alternatively validate connectivity among components of the virtual network system. For example, the certification engine 412 may verify that a virtual network manager (e.g., NSX Manager, NSX Management Pack (MP)) can communicate with a central control plane (e.g., the NSX Central Control Plane (CCP)), may verify that the central control plane can communicate with hypervisors, may verify that the virtual network manager can communicate with hypervisors, may verify that the virtual network manager can communicate with edges devices of the network, etc.

In some examples, the certification engine 412 iterates through each of the components of the virtual network system to verify that every component is operational and functioning as requested. The components to be verified may include data plane features (e.g., MacLimit & MAC Learning, MulticastSnooping, PacketCapture, SwitchSecurity, BackupRestore—L2, BackupRestore—L3, Bridging, ControlPlatform, DHCP Relay, L2, L3, QOS, Teaming, AggregationService, HeatMap, IPFIX, LLDP, PortConnectionTool, PortMirroring, SupportBundle, Traceflow, etc.), control plane features (e.g., CLI, Clustering, CCP-local control plane (LCP) Communication, Controller Database, Geneve, Headless Operation, Host movement between TZ, L2 isolates, L2 debug, Communications, Backup Restore, VXSTT, VLAN, virtual tunnel endpoint (VTEP) Property Change, etc.), Edge L2-L3 Features (e.g., Static Routing, Dynamic Routing, Distributed Routing, Backup Restore, CLI, Teaming, API and Performance, BGP, ECMP, Firewall, L2-L3, LLDP, L2-L3 Traceflow, RBAC, NAT, Packet Capture, Clustering, etc.), Edge L4-L7 Features (e.g., Central CLI, Tagging, Firewall, HA, Load Balancer, MDProxy, SSLVPN, IPSECVPN, SNMP, DHCP, LR, etc.), Management Plane (e.g., AAA RBAC, AAA CBAC, AAA TACAS, Grouping Objects, IDAS, Inventory, Tagging, IP Discovery, Threaddump, MultiVC, etc.), Platform features (e.g., Activity Framework, Aggregation Services, Appliance Management, Certificate Management, Backup Restore, Cipher Suites, CLI, Logging, DCNandStateSync, Messaging, MPA, SNMP, Syslog Infrastructure, Support Bundle, Clustering, Unified Appliance, Licensing, etc.), etc.

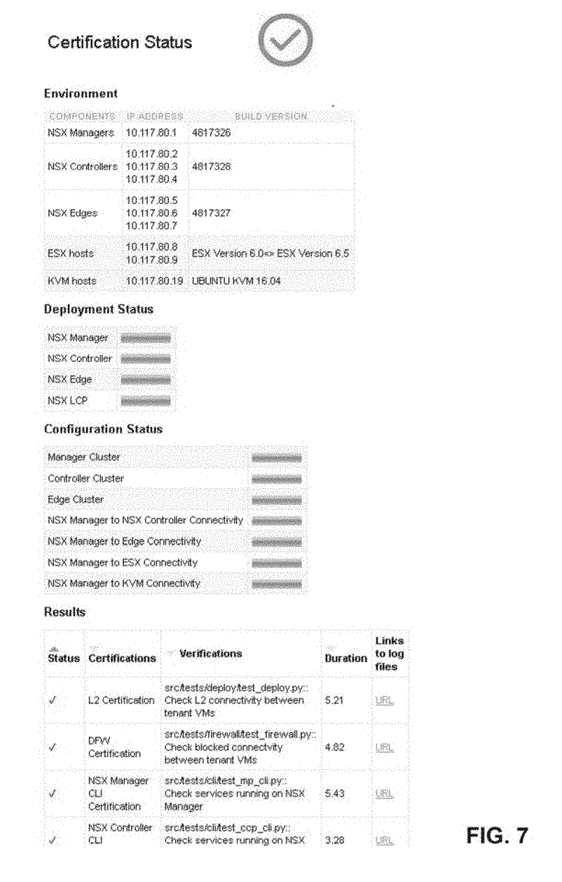

The example certification engine 412 outputs a report of certification testing via the example user interface 402. The example report indicates whether or not the deployment is certified. Example graphical user interfaces presenting the certification results are illustrated in FIGS. 6-7. The example report may indicate that the certification has passed, that the certification has failed, may identify steps that may be performed to remediate an error, etc.

The example rollback engine 414 and/or the example remediation engine 416 handle errors that are identified during certification by the example certification engine. For example, when the certification engine 412 determines that a policy/rule has not been met, the example rollback engine 414 may rollback configuration to a last known good configuration and/or the example remediation engine 416 may present information to the administrator 306 to enable the administrator 306 to decide how to address the error.

While an example manner of implementing the virtual networking deployment generator 150 of FIGS. 1 and/or 3 is illustrated in FIG. 4, one or more of the elements, processes and/or devices illustrated in FIG. 4 may be combined, divided, re-arranged, omitted, eliminated and/or implemented in any other way. Further, the example user interface 402, the example command line interface 404, the example execution engine 408, the example data center interface 410, the example certification engine 412, the example rollback engine 414, the example remediation engine 416 and/or, more generally, the example virtual networking deployment generator 150 of FIG. 3 may be implemented by hardware, software, firmware and/or any combination of hardware, software and/or firmware. Thus, for example, any of the example user interface 402, the example command line interface 404, the example execution engine 408, the example data center interface 410, the example certification engine 412, the example rollback engine 414, the example remediation engine 416 and/or, more generally, the example virtual networking deployment generator 150 of FIG. 3 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example, the example user interface 402, the example command line interface 404, the example execution engine 408, the example data center interface 410, the example certification engine 412, the example rollback engine 414, and/or the example remediation engine 416 is/are hereby expressly defined to include a non-transitory computer readable storage device or storage disk such as a memory, a digital versatile disk (DVD), a compact disk (CD), a Blu-ray disk, etc. including the software and/or firmware. Further still, the example virtual networking deployment generator 150 may include one or more elements, processes and/or devices in addition to, or instead of, those illustrated in FIG. 4, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

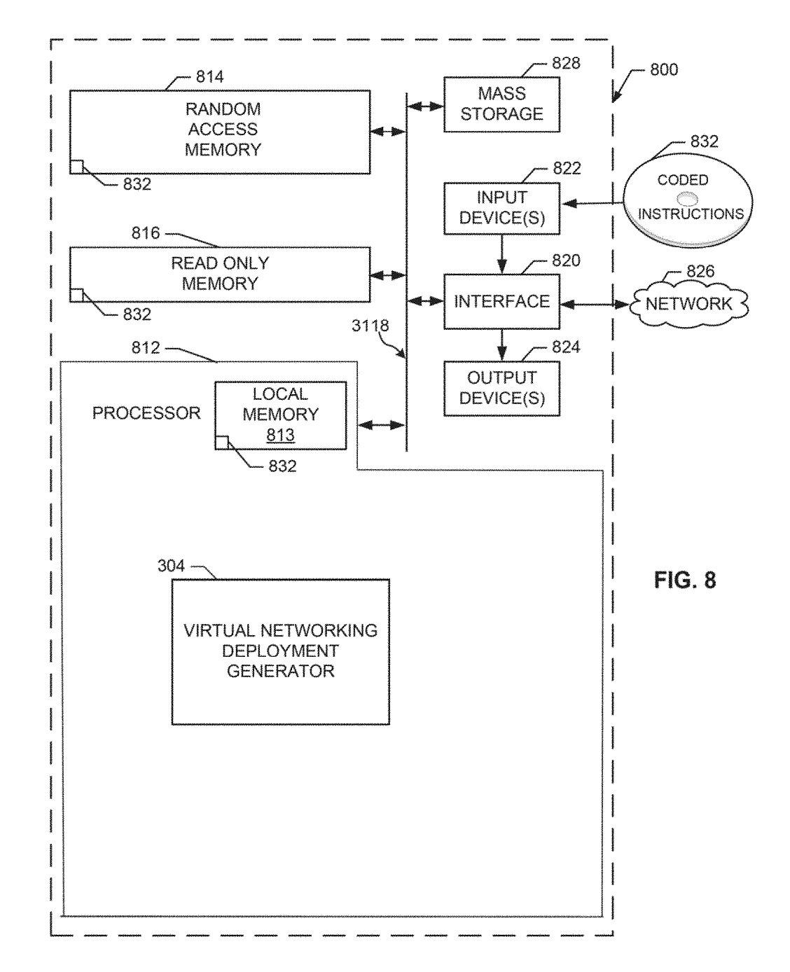

A flowchart representative of example hardware logic or machine readable instructions for implementing the virtual networking deployment generator 150 is shown in FIG. 4. The machine readable instructions may be a program or portion of a program for execution by a processor such as the processor 812 shown in the example processor platform 800 discussed below in connection with FIG. 8. The program may be embodied in software stored on a non-transitory computer readable storage medium such as a CD-ROM, a floppy disk, a hard drive, a DVD, a Blu-ray disk, or a memory associated with the processor 812, but the entire program and/or parts thereof could alternatively be executed by a device other than the processor 812 and/or embodied in firmware or dedicated hardware. Further, although the example program is described with reference to the flowchart illustrated in FIG. 4, many other methods of implementing the example apparatus 50 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

As mentioned above, the example processes of FIG. 5 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, and (6) B with C.

The program of FIG. 4 begins when the example user interface 402 and/or the example command line interface 404 of the example virtual networking deployment generator 150 receives configuration information for the deployment (block 502). According to the illustrated example, the configuration information includes topology details as well as use cases to be certified by the certification engine 412.

The example execution engine 408 deploys the virtual networking in the example data center 302 based on the identified configuration information (block 504). While example block 504 includes deploying a virtual networking system, other implementations may deploy a portion of a virtual networking system (e.g., a new component of a virtual networking system, a modification (e.g., a setting change), etc.). Alternatively, block 504 may be skipped where certification (e.g., blocks 506-514) is requested for an existing deployment. The example certification engine 412 validates the deployment of the virtual networking system to ensure that the deployment meets predetermined criteria (e.g., criteria identification by the example administrator 302) (block 506).

The example certification engine 412 generates a report of the results of the analysis of the certification and/or recommending steps for addressing errors identified by the example certification engine 412 (block 508). The example certification engine 412 determines if the certification passes (block 510). When the certification passes, the example certification engine 412 outputs a certification indicating that the virtual network deployment has met the identified rules/policies and is certified for operation within the example data center 302.

When the example certification engine 412 identifies an error (e.g., a rule/policy is not met following deployment), the example rollback engine 404 and/or the example remediation engine 406 attempt to correct the error (block 512). Control then returns to block 506 to re-validate the virtual network deployment.

FIG. 6 is an illustration of an example report that may be presented by the example user interface 402 to indicate that the certification tests have not passed. FIG. 7 is an illustration of an example report that may be presented by the example user interface 402 to indicate that the certification tests have passed.

FIG. 8 is a block diagram of an example processor platform 800 structured to execute the instructions of FIG. 5 to implement the virtual networking deployment engine of FIGS. 3 and/or 4. The processor platform 800 can be, for example, a server, a personal computer, a workstation, a self-learning machine (e.g., a neural network), a mobile device (e.g., a cell phone, a smart phone, a tablet such as an iPad′), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 800 of the illustrated example includes a processor 812. The processor 812 of the illustrated example is hardware. For example, the processor 812 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the virtual networking deployment generator 150.

The processor 812 of the illustrated example includes a local memory 813 (e.g., a cache). The processor 812 of the illustrated example is in communication with a main memory including a volatile memory 814 and a non-volatile memory 816 via a bus 818. The volatile memory 814 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 816 may be implemented by flash memory and/or any other desired type of memory device. Access to the main memory 814, 816 is controlled by a memory controller.

The processor platform 800 of the illustrated example also includes an interface circuit 820. The interface circuit 820 may be implemented by any type of interface standard, such as an Ethernet interface, a universal serial bus (USB), a Bluetooth® interface, a near field communication (NFC) interface, and/or a PCI express interface.

In the illustrated example, one or more input devices 822 are connected to the interface circuit 820. The input device(s) 822 permit(s) a user to enter data and/or commands into the processor 812. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 824 are also connected to the interface circuit 820 of the illustrated example. The output devices 824 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 820 of the illustrated example, thus, typically includes a graphics driver card, a graphics driver chip and/or a graphics driver processor.

The interface circuit 820 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 826. The communication can be via, for example, an Ethernet connection, a digital subscriber line (DSL) connection, a telephone line connection, a coaxial cable system, a satellite system, a line-of-site wireless system, a cellular telephone system, etc.

The processor platform 800 of the illustrated example also includes one or more mass storage devices 828 for storing software and/or data. Examples of such mass storage devices 828 include floppy disk drives, hard drive disks, compact disk drives, Blu-ray disk drives, redundant array of independent disks (RAID) systems, and digital versatile disk (DVD) drives.

The machine executable instructions 832 of FIG. 5 may be stored in the mass storage device 828, in the volatile memory 814, in the non-volatile memory 816, and/or on a removable non-transitory computer readable storage medium such as a CD or DVD.

The foregoing methods, apparatus, and articles of manufacture facilitate the deployment of a virtual networking system in a data center. In some examples, providing a single interface that may be utilized for deploying and configuring various aspects of a virtual network system may reduce errors/mistakes when deploying virtual networking. In some examples, deployment and certification actions are implemented automatically to reduce the burden on the administrator and/or reduce the time period for deployment. In some examples, deploying using the virtual networking deployment generator provides increased quality by early detection of production problems that allows remediation of the errors earlier in the deployment process. By increasing the reliability of network system deployment, in some examples, customer confidence in the virtual network system is increased. The example certification provides evidence to an administrator that the virtual network system is properly configured and provides information regarding the expect operation of the virtual networking system in the data center. In some examples, by performing deployment and analysis in a customer environment (as opposed to a testing lab) provides clear information about how the virtual networking system will operate in the customer's actual environment.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. An apparatus comprising:
a user interface to receive configuration information for a virtual network system to be installed in a datacenter and to store the configuration information in a configuration file;
an execution engine to install the virtual network system within the datacenter, deploy a virtual network topology specified in the configuration file, and to configure the virtual network system based on the configuration file; and
a certification engine to validate the deployment and, in response to detecting a deployment failure, to present, via the user interface, options to respond to the failure.

2. An apparatus as defined in claim 1, wherein the certification engine is to present an instruction for correcting the failure.

3. An apparatus as defined in claim 2, further including a remediation engine to present the instruction.

4. An apparatus as defined in claim 1, wherein the certification engine is to present an option for rolling back the install.

5. An apparatus as defined in claim 4, further comprising a rollback engine to communicate with the datacenter to roll back the install.

6. A non-transitory computer readable medium comprising instructions that, when executed, cause a machine to at least:
receive configuration information for a virtual network system to be installed in a datacenter and store the configuration information in a configuration file;
install the virtual network system within the datacenter;
deploy a topology specified in the configuration file;
configure the virtual network system based on the configuration file;
validate the deployment; and,
in response to detecting a deployment failure, present, via the user interface, options to respond to the failure.

7. A non-transitory computer readable medium as defined in claim 6, wherein the instructions, when executed, cause the machine to present an instruction for correcting the failure.

8. A non-transitory computer readable medium as defined in claim 6, wherein the instructions, when executed, cause the machine to present an option for rolling back the install.

9. A non-transitory computer readable medium as defined in claim 6, wherein the instructions, when executed, cause the machine to communicate with the datacenter to rollback the install.

10. A method comprising:
receiving configuration information for a virtual network system to be installed in a datacenter and store the configuration information in a configuration file;
installing the virtual network system within the datacenter;
deploying a topology specified in the configuration file;
configuring the virtual network system based on the configuration file;
validating the deployment; and,
in response to detecting a deployment failure, presenting, via the user interface, options to respond to the failure.

11. A method as defined in claim 10, further including presenting an instruction for correcting the failure.

12. A method as defined in claim 10, further including presenting an option for rolling back the install.

13. A method as defined in claim 10, further including communicating with the datacenter to roll back the install.

14. An apparatus comprising:
a datacenter interface to couple the apparatus to a production datacenter; and
a certification engine to:
retrieve information about an installation of a virtual network system from a datacenter;
compare the information about the installation of a virtual network system in the datacenter to a predetermined rule; and
in response to detecting a failure to satisfy the predetermined rule, present an indication of the failure.

15. An apparatus as defined in claim 14, wherein the predetermined rule indicates checking if the configuration information identified in the configuration file has been retained in the deployed production datacenter.

16. An apparatus as defined in claim 14, wherein the predetermined rule indicates checking if services for a management plane and a control plane of the virtual network system are running.

17. An apparatus as defined in claim 14, wherein the predetermined rule indicates checking if a management plane can communicate with a policy plane of the virtual network system.

18. An apparatus as defined in claim 14, wherein the predetermined rule indicates checking if virtual machines in the datacenter have layer 2 connectivity with overlay network internet protocol addresses identified in the configuration file.

19. An apparatus as defined in claim 14, wherein the certification engine to verify proper operation of at least one of data plane features, control plane features, edge layer 2 to layer 3 features, edge layer 4 to layer 7 features, management plane features, and platform features of the virtual network system.

20. An apparatus as defined in claim 14, wherein the certification engine is to compare the information about the installation to the rule by iterating over a plurality of components of the virtual network system and comparing information about the plurality of components to a plurality of rules, respectively.

21. A non-transitory computer readable medium comprising instructions that, when executed, cause a machine to at least:
retrieve information about an installation of a virtual network system from a datacenter;
compare the information about the installation of a virtual network system in the datacenter to a predetermined rule; and
in response to detecting a failure to satisfy the predetermined rule, present an indication of the failure.

22. A non-transitory computer readable medium as defined in claim 21, wherein the predetermined rule indicates checking if the configuration information identified in the configuration file has been retained in the deployed production datacenter.

23. A non-transitory computer readable medium as defined in claim 21, wherein the predetermined rule indicates checking if services for a management plane and a control plane of the virtual network system are running.

24. A non-transitory computer readable medium as defined in claim 21, wherein the predetermined rule indicates checking if a management plane can communicate with a policy plane of the virtual network system.

25. A non-transitory computer readable medium as defined in claim 21, wherein the predetermined rule indicates checking if virtual machines in the datacenter have layer 2 connectivity with overlay network internet protocol addresses identified in the configuration file.

26. A method comprising:
retrieving information about an installation of a virtual network system from a datacenter;
comparing the information about the installation of a virtual network system in the datacenter to a predetermined rule; and
in response to detecting a failure to satisfy the predetermined rule, presenting an indication of the failure.

27. An apparatus as defined in claim 26, wherein the predetermined rule indicates checking if the configuration information identified in the configuration file has been retained in the deployed production datacenter.

28. An apparatus as defined in claim 26, wherein the predetermined rule indicates checking if services for a management plane and a control plane of the virtual network system are running.

29. An apparatus as defined in claim 26, wherein the predetermined rule indicates checking if a management plane can communicate with a policy plane of the virtual network system.

30. An apparatus as defined in claim 26, wherein the predetermined rule indicates checking if virtual machines in the datacenter have layer 2 connectivity with overlay network internet protocol addresses identified in the configuration file.
